(19) United States
(12) Patent Application Publication
(10) Pub. No.: US 2015/0095164 A1
(43) Pub. Date: Apr. 2, 2015

(54) INTERACTIVE HOST-AWARE CONTENT

(71) Applicant: Microsoft Technology Licensing, LLC, Redmond, WA (US)

(72) Inventors: Shankar Vaidyanathan, Sammamish, WA (US); Balbir Singh, Redmond, WA (US); Phani K. Vaddadi, Bellevue, WA (US)

(21) Appl. No.: 14/564,778

(22) Filed: Dec. 9, 2014

Related U.S. Application Data
(62) Division of application No. 12/061,503, filed on Apr. 2, 2008.

(51) Int. Cl. G06Q 30/02

(52) U.S. Cl. CPC G06Q 30/0269; G06Q 30/0251
USPC 705/14.66; 705/14.49

(57) ABSTRACT

Embodiments of the invention provide a method and system, for enabling an advertisement to interact with a software application. This can include receiving advertising content that is to be hosted by a software application. The advertising content can include an advertisement to be presented as well as an object that includes product information. The object can be interacted with by the software application. The product information relates to a product offering that is being promoted by the advertisement. The method further includes presenting the advertisement within the software application, and enabling the software application to utilize the product information in a presentation that becomes part of a work of the software application. The software application can be used to modify imported product information. Links to the outside world enable dynamic updating of even the imported product information, and also enable transactions to be performed that are associated with the advertisement.

### PRIORITY

This application claims priority and is a divisional of application Ser. No. 12/061,503, Attorney Docket No. 322778.01/MFCP.139037, filed 2 Apr., 2008, which is incorporated herein by reference in the entirety

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. At a high level, our disclosure describes methods and systems for enabling an advertisement to interact with a software application. An advertisement becomes a special advertisement such that it is associated with product information as well as other data that enables it to interact with a software application, and thereby making the advertisement persistent or what some refer to as “sticky.”

One way of interacting with a software application is to provide for the importing of product information into a software application incident to, for example, dragging an advertisement into a work that is associated with a software application. Even though the product information was imported into the software application, it can still enjoy a link to the outside world and be dynamically updated automatically by way of a web service or other similar technology. This stickiness factor helps close the loop between advertising and commerce. Moreover, a transaction-initiation component can be included in the imported information so that a user can utilize such a component to at least begin a transaction even if that beginning happens much later in time after an initial importing of the product information.

### BRIEF DESCRIPTION OF THE SEVERAL VIEWS OF THE DRAWINGS

Embodiments of the invention are described in detail below with reference to the drawing figures, which form a part of this disclosure, and are incorporated by reference herein, and wherein:

FIG. 1 depicts an illustrative operating environment suitable for practicing an embodiment of the invention;

FIG. 2 depicts a block diagram illustrating certain components of an illustrative computing device suitable for practicing an embodiment of the present invention;

FIG. 3 depicts an illustrative software application before an advertisement is caused to be interacted therewith;

FIGS. 4-5 illustrate product information having then imported into a software application according to an embodiment of the present invention;

FIGS. 6-7 indicate an illustrative way of describing how to import product information in accordance with an embodiment of the present invention; and

FIG. 8 depicts an illustrative method of enabling an advertisement to interact with a software application according to an embodiment of the present invention.

### DETAILED DESCRIPTION

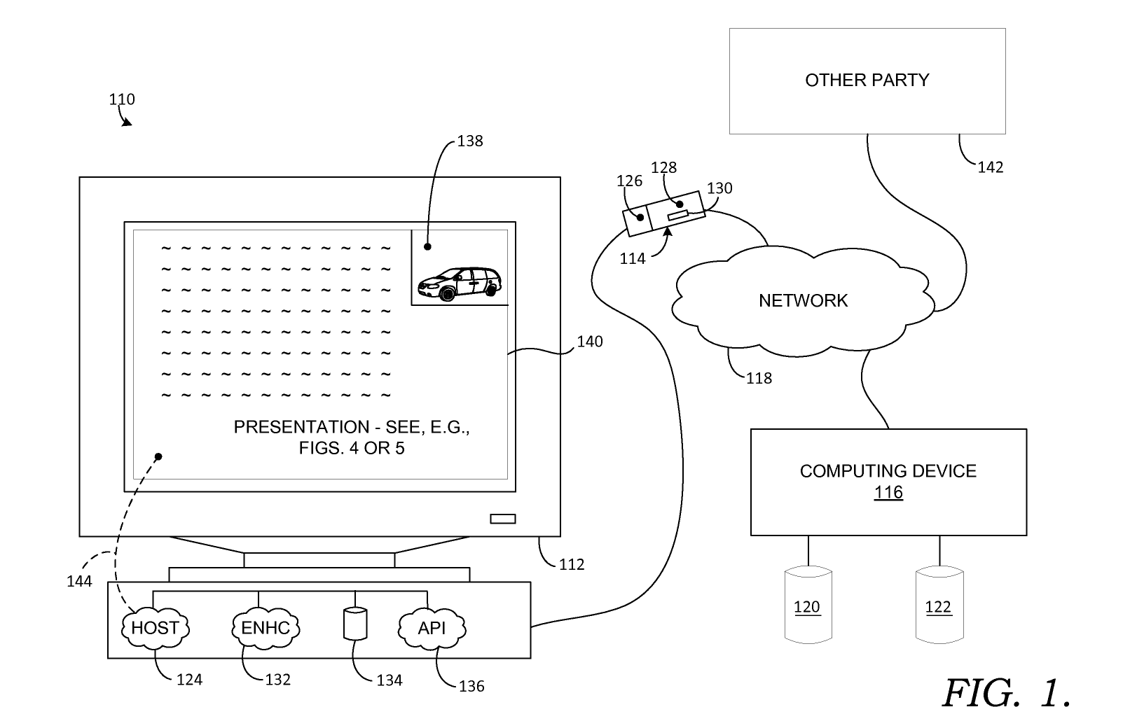

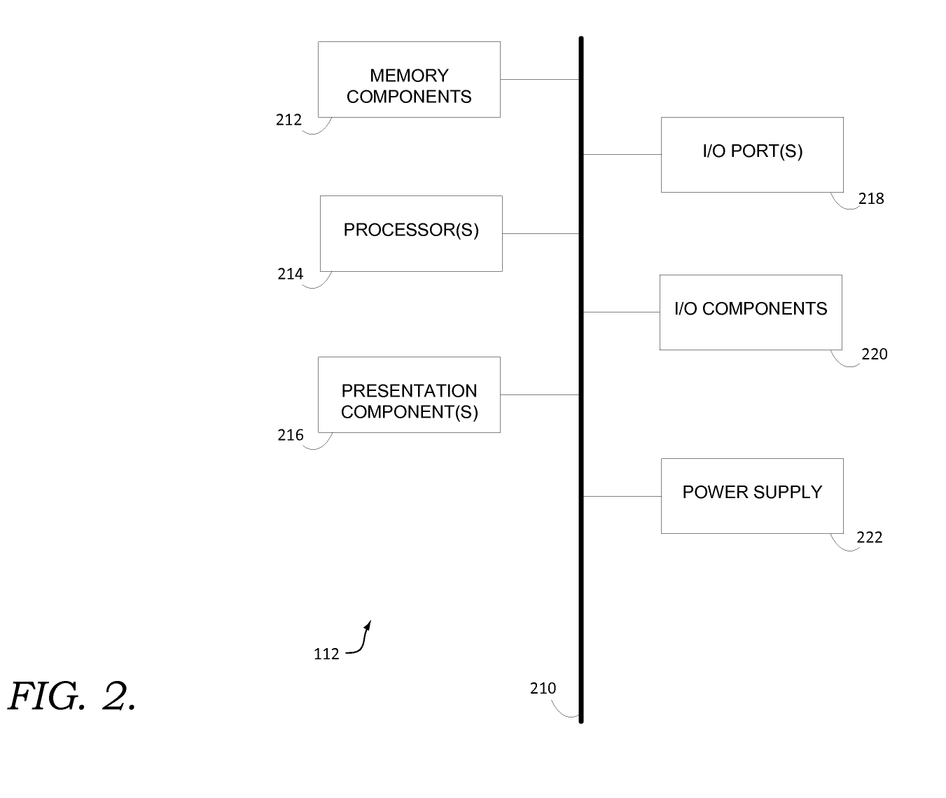

Turning now to FIG. 1, an illustrative operative environment suitable for practicing an embodiment of the invention is provided and referenced generally by the numeral 110. Operating environment 110 includes a client device 112, which is schematically described in greater detail in connection with FIG. 2.

Client device 112 will receive advertising content 114 from computing device 116 by way of network 118. Although we sometimes refer to certain items in the singular, we do not mean to imply that only one of such items is implicated. For example, although we refer to network 118 in the singular, in reality, it may include a set of networks. This concept is applicable to a great many items throughout this disclosure. We avoid persistently qualifying terms so as to enhance readability but not to substantively indicate singularity of items. Another example includes our reference to computing device 116, which may actually be composed of various components that help facilitate providing advertising content to client device 112.

Illustrative components that may be part of or coupled to computing device 116 to facilitate its communication of advertising content includes an ad store 120 as well as another data store 122 that houses interaction data options. Interaction data options 122 describe different ways that different portions of advertising content 114 might interact with a host application 124 that is being presented on client device 112. We will describe these different interaction options in greater detail below; but summarily, product information can be presented in different forms based on the type of host application that host application 124 is. Ad store 120 stores advertisements that are communicated from computing device 116.

Advertising content 114 includes an advertisement 126 as well as an object 128 that includes product information 130. As we will explain, object 128 can be interacted with by a software application such host application 124. Product information 130 can be imported into host application 124 incident to an occurrence of an event (such as a set of click actions, dragging and dropping, a set of key sequences, etc.).

Advertising content 114 is received by computing device 112. By way of illustration, computing device 112 includes a software enhancement 132, a data store 134, and an application program interface (API) 136. Software enhancement 132 may be known by a variety of names to ordinary skilled artisans. For example, enhancement 132 may take the form of a plug-in to host application 124. To the extent there is a difference, and it is referred to differently, enhancement 132 might also be known as an add-in. One of the roles of enhancement 132 in an embodiment of the present invention is to enable host application 124 to interact with either API 136 or advertising content 114 directly. As we will explain, portions of advertising content 114 can actually be imported into host application 124 (variously referred to herein as software application 124). In some embodiments, host application 124 is modified so that it can interact with advertising content 114. In other embodiments, software application 124 is enhanced with enhancement 132 so that it can take advantage of the additional functionality offered by some embodiments of the present invention.

Data store 134 might be used to store certain portions of advertising content 114. In some embodiments, data store 134 stores advertising data to help facilitate rotating advertisements that are presented in a user interface portion 138 of display 140. In other embodiments, data to rotate advertisements is received live, and data store 134 is not used.

In some embodiments, API 136 provides a level of interoperability between software application 124 and advertising content 114. In some embodiments, API 136 helps digest or parse data contained in object 128. It can also help facilitate carrying out various instructions associated with object 128.

Also shown in FIG. 1 is another party, which is referenced by numeral 142. As will be explained, advertising content 114 is provided to computing device 112 where it is enabled to be interacted with by way of software application 124. We refer to this item as another party because it may not be the same party that owns computing device 116. For example, computing device 116 may facilitate a presentation of advertising content to client device 112, but an advertisement might be associated with a vendor. If a user acts on a transaction-initiation control, then that user might be directed to a vendor's website. In another example, usage information associated with advertising content 114 might be communicated from client device 112 to other party 142. Thus, other party 142 may take on a variety of forms.

Software application 124 can take on a variety of forms itself. For example, software application 124 might be a word-processing application, a spreadsheet application, a database program, a presentation program, a drawing program, a messaging application, an application development application, a finance-related application, a productivity-enhancement application, and the like. Illustrative messaging applications include applications that allow for a calendaring of events or sending and receiving e-mail or other types of messages. Dashed line 144 conveys that software application 124 might be presented on a display 140.

As will be explained in greater detail below, a UI portion 138 presents advertisement 126 in one embodiment. In one embodiment, UI portion 138 might be known as an ad panel. An ad panel can be a portion of a user interface that is resolved for receiving advertisements such as advertisement 126.

Advertisement 126 might appear similar to the way a prior-art advertisement would appear to a user. But it is not the same. Advertisement 126 is a special advertisement. Namely, it is associated with object 128. Object 128 includes interaction data as well as product information 130. Product information 130 is information that is related to a product offering that is associated with advertisement 126. For example, if advertisement 126 is related to cars, then product information 130 might include information related to the purchase of a new car; perhaps a single car, or perhaps multiple cars.

Product information 130 might also include information on selling a car instead of purchasing a car. If advertisement 126 were advertising financial-related information, then product information 130 might take the form of various stock brokers or entities that can manage a person's money. In some situations, ad 126 is directly related to product information 130. In other embodiments, product information 130 might be more tenuously related to advertisement 126. For example, advertisement 126 might be some sort of generic music-related offering, and product information 130 might take on various forms ranging from books related to music to restaurants that play live music in a certain geographic location.

Regarding the nature of product information 130, it might be textual, an image, a multimedia file, a video, audio, or combinations of the same. It might also include transaction-related information that includes data that can be leveraged to at least start, or in some cases even complete, a transaction associated with a product offering that is the subject of an advertisement. Illustrative transactions include purchasing an item, requesting more information about a service, providing feedback, sending information, receiving information, and the like. A transaction is initiated by an element that has been imported into software application 124.

In one embodiment, advertisement 126 is based on user information found in connection with the profile data of a user. For example, a cookie might reside on client device 112. This cookie might gather profile information associated with a user. For example, a user might visit certain car-buying sites in a specific geographic region. The cookie would know of both the sites visited as well as information that indicates a geographic location of the user. This information is used in one embodiment to determine what ads to even send down to client device 112. If multiple users are associated with client device 112, then information may be determined based on login such that each person logging into client device 112 has different cookies associated with him or her.

In another embodiment, the functionalities offered by the present invention can be handled by way of a subscription paradigm wherein a user logs into a product offering or even something that grants access to host application 124. This product offering will then utilize the login information to determine what ads to send to software application 124. In such a situation, the advertisements are not tied to the client device 112, but are tied to a user. An illustrative example of this includes web-based applications. For example, an internet-related company might offer online e-mail or even online applications such as word-processing applications or spreadsheet applications. These might be accessed incident to providing login credentials. After these login credentials are provided, a profile can be accessed that is associated with the login credentials. This profile can be used to determine what type of advertising content 114 to provide to a given user by way of client device 112. We will now provide a general overview of computing device 112 in connection with FIG. 2.

Turning to FIG. 2, a diagrammatic block diagram of computing device 112 is provided. Computing device 112 may take on a variety of forms, including, for example, a computing device such as a gaming console, a client computer, a server computer, variations thereof such as laptop computers and palm-top computers, and in some embodiments devices such as PDAs and smart phones. As shown in FIG. 2, a bus 210 couples one or more memory components 212 to one or more processors 214, various presentation components 216, input/output ports 218, input/output components 220, and at least one power supply 222. Other devices including lower level aspects of the shown devices are not shown so as to not obscure the invention.

Memory components 212 include things such as a hard drive, volatile memory (such as RAM), buffers, and the like. The one or more processors 214 control overall data communications throughout computing device 112. Illustrative presentation components 216 include a video card as well as a monitor or other presentation device. Input/output ports 218 provide connectivity to peripheral components such as printers, digital cameras, and the like. Actual input/output components may be things like printers and the like. A power supply 222 provides power to run computing device 112. Not all of the components shown in FIG. 2 need to be present in order to make up a computing device but are shown for illustrative purposes in connection with describing an embodiment of the invention.

Although the various blocks of FIG. 2 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. We recognize that such is the nature of the art and reiterate that the diagram of FIG. 2 is merely illustrative of an exemplary computing device that can be used in connection with one or more embodiments of the present invention.

Computing device 112 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices; carrier wave; or any other medium that can be used to encode desired information and be accessed by computing device 112.

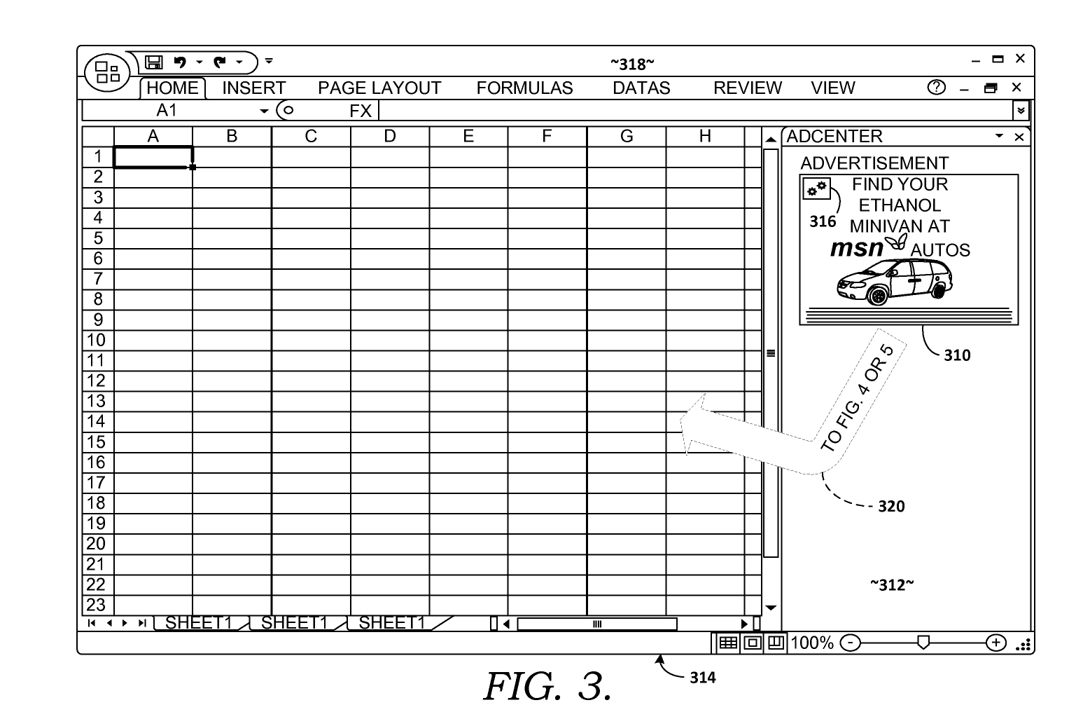

We will describe some lower level aspects of our invention in connection with FIGS. 3-7. Turning first to FIG. 3, an advertisement 310 is presented in an area 312 of a user interface 314 of a software application. In the example shown, the software application of FIG. 3 is a spreadsheet application. Although advertisement 310 may appear to be an ordinary advertisement, it is actually a special advertisement. The specialness of advertisement 310 can be denoted in a variety of ways. An illustrative way to indicate that advertisement 310 can be interacted with is to provide some sort of marker, which is referenced by numeral 316.

Marker 316 may take the form of a stagnant presentation or a dynamic presentation that includes some animation to convey that advertisement 310 is not a normal advertisement. Other ways of indicating that advertisement 310 can be interacted with are legion. For example, perhaps advertisement 310 is surrounded by a bold border (not shown). Perhaps advertisement 310 actually includes wording that indicates that it can be interacted with (also not shown). In some embodiments, no indication that advertisement 310 is a special advertisement is provided. In such a case, although a user might not immediately know that advertisement 310 can be interacted with, it nevertheless can.

Advertisement 310 is special because it is associated with object 128. What object 128 enables is an interaction between software application 318 and advertisement 310. An interaction method can be employed so that advertisement 310 interacts with software application 318. Illustrative interaction methods include dragging advertisement 310 to a destination associated with software application 318. Destinations may vary with different types of software applications. For example, in the case of spreadsheet application 318, an illustrative destination might include any of the spreadsheets of the workbook, namely, anywhere in the grid area. Other interaction methods include double clicking the advertisement 310, completing a key sequence that invokes the interaction method, or automatically adding product information based, at least in part, on a portion of the advertising content.

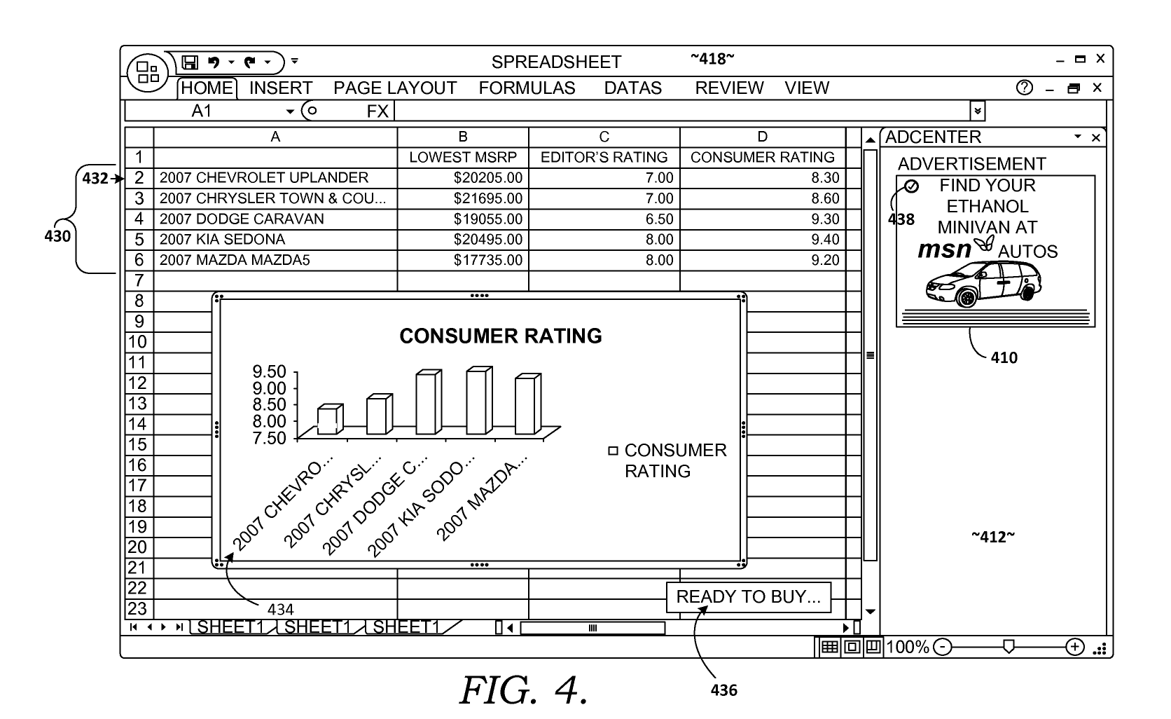

In this example, perhaps a user has indicated that she wishes to automatically have a new spreadsheet populated with product information any time a certain ad related to a certain product offering rotates through ad panel 312. In such an embodiment, perhaps advertisements rotate through concert information, restaurant information, and automobile information. Every time a concert-related advertisement is presented, its corresponding product information is automatically imported into software application 318. Arrow 320 referentially indicates a dragging- and dropping-motion wherein advertisement 310 is dragged and dropped into a grid portion of software application 318. Doing so might result in a presentation along the lines of that depicted in FIG. 4.

FIG. 4 includes unique reference numerals, but does so mainly because of the nature of a patent application. Being able to reference specific items and to be clear is important. But we do not mean to convey that the spreadsheet 418 is a different spreadsheet than that of FIG. 3. We will try to use like reference numerals to refer to like items. As can be seen in FIG. 4, five rows of data 430 have been added, including a first row 432. What has happened is that incident to dragging and dropping advertisement 310 into software application 418, product information has been imported into a work of software application 418. A work might be any type of fruit of a software application. For example, in the case of a word-processing application, a work might be a word-processing document.

Other illustrative works include a spreadsheet or workbook, a presentation, a database, a web-based application, a drawing file, a message, or a calendaring-related item. In the case of FIG. 4, the relevant work is a spreadsheet. More than just the five rows of data 430, other product information includes a chart 434 as well as a transaction-initiation control 436, which takes the form of a button, which in this case, includes the text “ready to buy.” Of course other textual indication could be provided such as “buy it,” “go get it,” and the like. Although a button is shown, the transaction-initiation control does not need to take the form of a button. In some embodiments, it may take the form of a hyperlink or some other control that a user can interact to at least initiate a transaction related to the advertisement. This can be the case even if application 418 is closed down and then reopened. Moreover, the product information (430, 434, 436) will be immediately available and presented in the relevant software application without even the need to receive any additional data.

Thus, by dragging and dropping an advertisement according to an embodiment of the invention into a software application, product information has been presented by way of the software application in which the advertisement was residing. In the case of the example of FIG. 4, information such as multiple vehicles including a manufacturer's suggested retail price, editor's rating, and a consumer rating are provided. The column headings can be hyperlinked to different agencies or vendors such that clicking on one of them will take the user to a website or other location to get more information about the relevant heading. Chart 434 was automatically created based on the data in object 128.

The product information seen is stagnant in some embodiments but dynamic in other embodiments. For example, the data in the five rows 430 shown can be updated automatically. That is, a web service or other similar technology can be leveraged to maintain a link to the outside world. Thus, we communication to network 118, if the price of “2007 Chevrolet Uplander” changes to $21,000, then the data cell B2 can be updated automatically to reflect that amount in one embodiment.

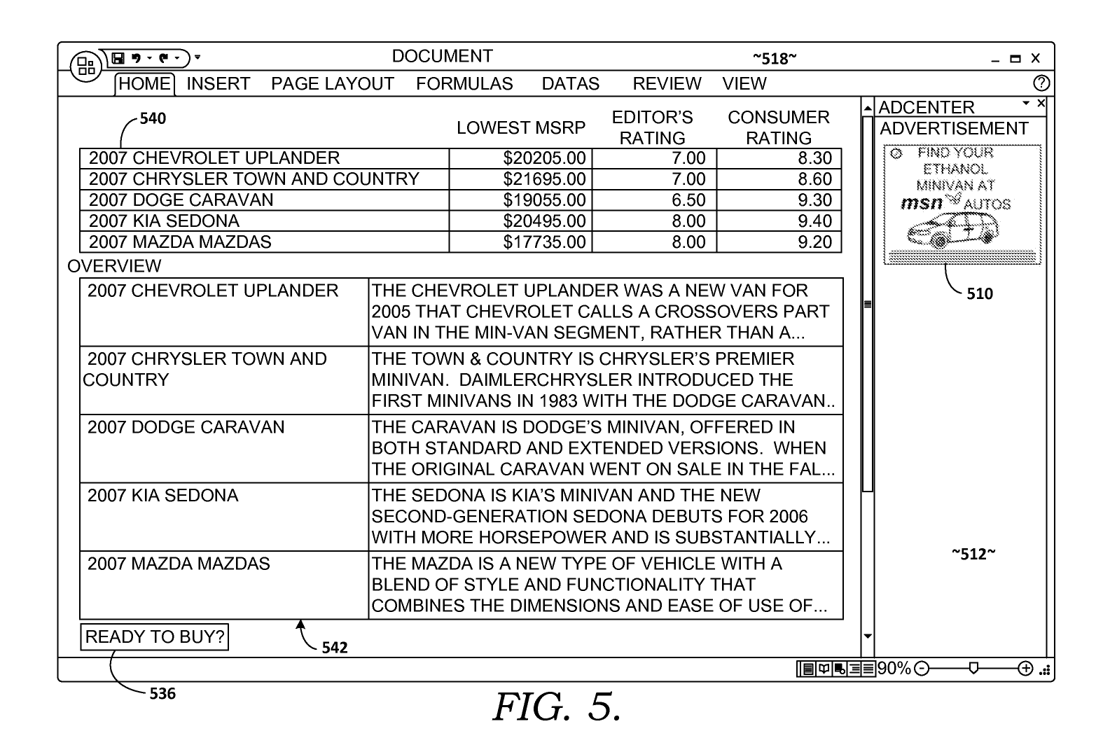

As mentioned, advertisement 410 is host aware. That is, advertisement 410 is associated with product information that might be interpreted differently by different software applications. Consider the example of FIG. 5. In FIG. 5, reference numeral 510 is intended to refer to the same advertisement 310 that was depicted in FIG. 3. The only thing that is changed is that this advertisement 510 is now being presented in a word-processing application 518. Now, when advertisement 410 is dragged from area 512 into software application 518, product information 130 takes on a different form. In some embodiments, taking on a different form means displaying different data. In other embodiments, taking on a different form means displaying the same data differently.

By way of example, the product information in word-processing application 518 includes a first table 540 as well as a second table 542. In the example, table 540 has similar characteristics to the rows 430 of data in FIG. 4. But because this is a word-processing application, the same data is utilized by a different application in a different way; namely, a table is presented instead of grids of a spreadsheet being populated. An overview table 542 is also provided. This overview table 542 was not provided in spreadsheet application 418. Although it could have been, perhaps by way of a text box, these types of decisions can be left to application developers.

For example, application developers can decide how they want their software applications to utilize the data contained in object 128. By way of example, we have shown that a spreadsheet application might be interested in presenting a chart 434 of data, whereas a word-processing application 518 might be interested in presenting a table 542 that includes a more wordy description of data that is common to both applications (e.g., that of rows 430 and table 540). A transaction-initiation control 536 is also shown in FIG. 5. Having briefly described at least two examples in a somewhat lower level of detail, we will expand on these scenarios a little more abstractly and also describe a couple of other illustrative scenarios. We might generally refer to reference numerals in FIG. 1 if when making general references, but if the scenarios that we are about to describe overlap with certain items of certain figures, then we might refer to those figures for clarity.

In a first scenario, similar to what we have mentioned prior, suppose that a family wants to shop for an ethanol-powered minivan. A user can initiate a spreadsheet application that is either modified or includes an enhancement such as enhancement 132 so that advertisements are presented in a screen area of the application. Client 132 understands not only the customer's profile, but also context and behavior across a desktop machine and devices that are used either at an office, a home, or even on the move. Rich advertisements are provided to client device 112. An indicator such as that of 316 denotes that an advertisement can be interacted with. Dragging and dropping an advertisement into host application 124 initiates a match up that was powered by the internet. Data for comparing and contrasting different options that can help a user make a decision is now presented within software application 124 itself.

Moreover, the product information imported can be edited by way of the relevant software application. Still further, if desired, user edits to imported product information can be communicated back to an advertisement provider or a third party 142. For example, suppose an individual started off with a list of five cars. But then the user deleted two of the rows that were associated with two of the cars. In one example, perhaps those deletions are communicated back to all parties; such that the owners of the products that were shown in the rows that got deleted might know now to send a special offer. Similarly, the remaining potential vendors may also be more highly motivated to send a special product offering as its chances for success increase. In some embodiments, an indication can be provided that indicates that advertisement 126 has been dragged into software application 124. An illustrative indication is referenced by numeral 438 in FIG. 4.

As noted, the data provided to software application 124 did not necessarily have to have been created at the time of serving the advertisement 126. Product information 130 could come from a web service, or equivalent, at the time of causing advertisement 126 to interact with host application 124. This permits a late binding targeting in other words. Moreover, once advertising content 114 provides data to software application 124, that data does not need to be static. We briefly mentioned this in the past. The product information 130 could be live data that changes as market and timeframes change. For example, if the same spreadsheet 418 is reopened months later, the data (430, 434, and/or 436) could reflect current information. Certain cars may no longer be available and pricing might have changed.

Consider also a web scenario. Users of an online mail application might be discussing a next vacation to a certain destination or set of destination possibilities. Travel options begin showing up in the side panel (e.g., 312, 412, 512). These are intelligent objects capable of providing rich information and also capable of storing and sharing a user's planned schedule for later use. If a particular advertisement is shown that is of interest, it can be acted on so as to interact with a messaging program, including a mail program, even if that mail program is web-based. Technologies such as AJAX and the like make this possible. In this example, a new mail message might be composed with various options for travel already configured. Several possible departure dates are automatically populated with relevant dates and times based on profile information gleaned from the user's profile.

For example, flights flying out of a certain city and to a certain city. The user can experiment with different possibilities and pick a date surrounding a given time frame. Satisfied with a given selection, the mail message can be sent to other parties of interest. Moreover, if the recipient opts to make changes, then when the original sender views his information, the changes are automatically reflected. Thus, if a person's travel plans were changed by another person, then those changes will be automatically reflected. Instead of a “ready to buy” button, a transaction-initiation control directed to “finalize travel” could be provided in the person's web-based mailing application. Acting on this control could cause at least an initiation of a transaction to begin. In some embodiments, the entire transaction can be completed with the click of a button. In other embodiments, clicking such a transaction-initiation control takes a user to a vendor's website to help complete a given transaction.

Consider a developer scenario. In this example, suppose an individual is using an application-development application. While working toward a database project, a toolbox begins populating with interesting targeted ads. In this case, the UI areas such as 312, 412, and 512 are not so large and actually consume spaces such as buttons or toolboxes as part of seamlessly integrating into a software application. Whereas a typical next step might be to retrieve a dataset and populate a data grid in a form designer, because advertising content 114 is host aware, the advertisements come mainly from database companies that provide tools for database development in administration.

As different capabilities are understood by a developer, a respective advertisement icon can be clicked on to initiate an interaction with the development application. Relevant code is actually added to the person's application through a mechanism such as a language-neutral component to help with a next step of retrieving datasets and displaying them in the data grid of a form. A developer can also see code differentiations before they are approved in some embodiments. This is an example where we mean to convey that a broad definition should be given to the term “product information.” Product information doesn't necessarily relate to information for sale in connection with a product offering. Rather, it may be information such as programmatic code that we have just described in connection with a developing context.

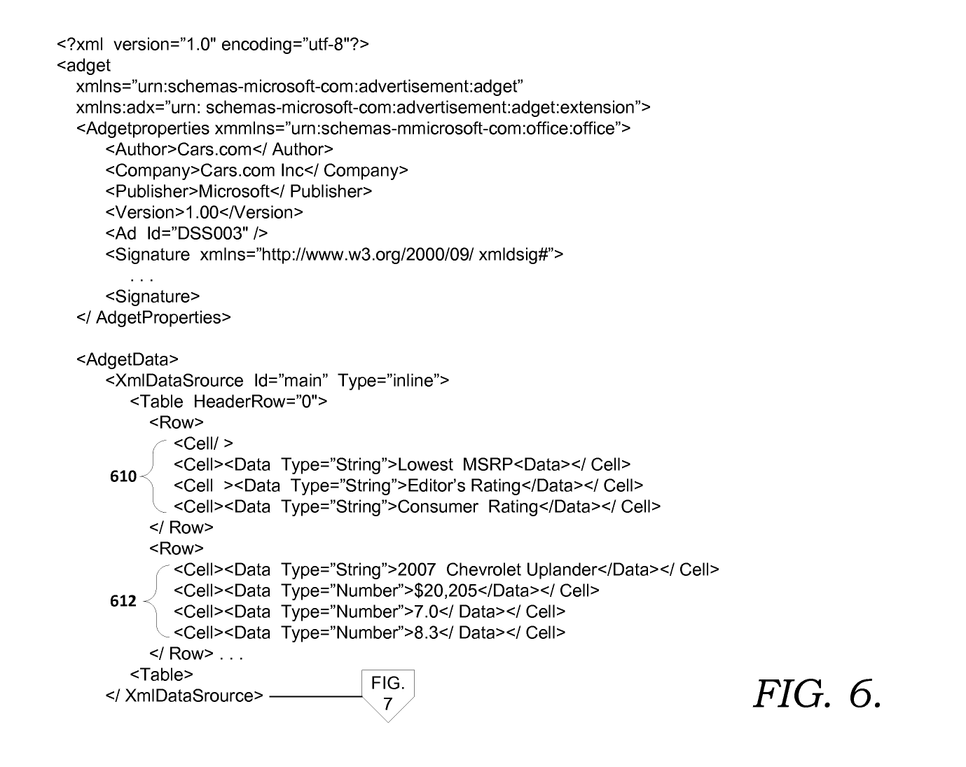

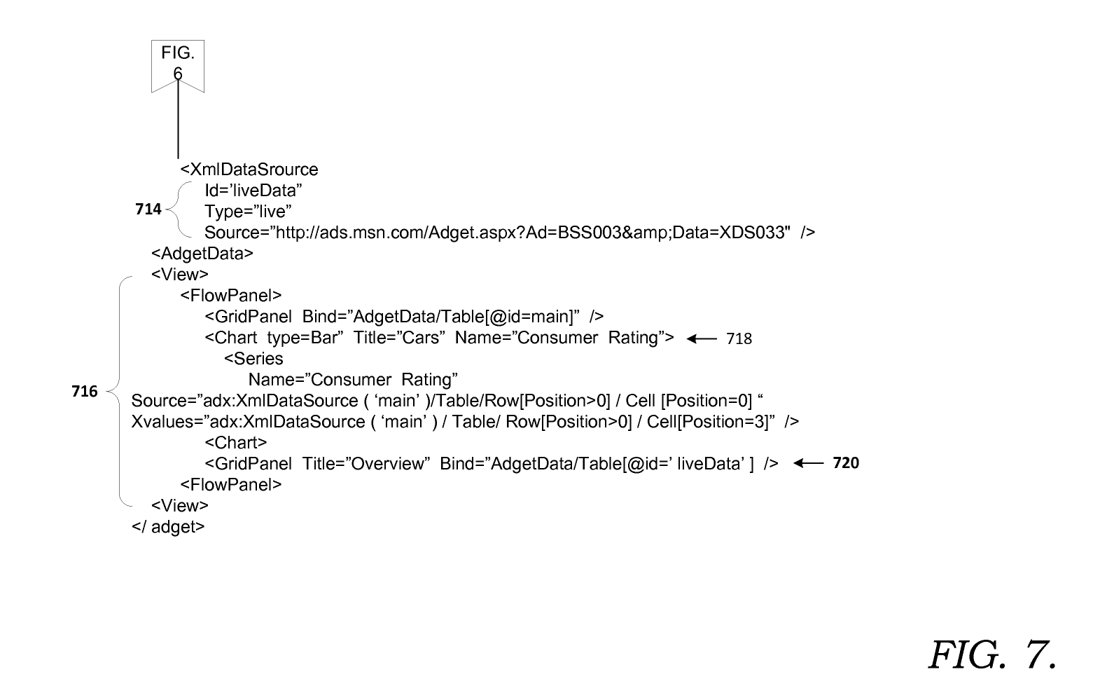

There are various ways to facilitate an interaction between advertising content 114 and software application 124. We will describe one method for illustrative purposes, but it should not be construed as limiting in nature. An illustrative example that we will show will be in the context of an XML component. With initial reference to FIG. 6, code portion 610 corresponds to the column headings in FIGS. 4 and 5. Code portion 612 indicates a first row of data, namely row 432 in FIG. 4 and the corresponding row in table 540 of FIG. 5. We do not show all the rows for the sake of simplicity. Code portion 612 and the others not shown describe an example of static data. But, as mentioned, data might also be live. Thus, with reference to FIG. 7, code portion 714 indicates how live data could be used to source product information instead of stagnant data.

View information 716 provides an example of how different applications can show the same data differently, or show different data. For example, line 718 corresponds to a portion of information describing bar chart 434 of FIG. 4. Series, source values, and other values are also described. Moreover, line 720 is relevant to table 542 of FIG. 5 in that it defines a grid panel. In this way, it can be seen how different applications can opt to include different forms of the same data. For example, a word-processing application might opt to skip over the information associated with the chart that is described in line 718. Similarly, a spreadsheet application might opt to ignore grid panels, such as that associated with line 720 in FIG. 7. Again, we do not imply that the illustrative scheme of FIGS. 6 and 7 is restrictive, but provides at least one example to illustrate different functional aspects of the present invention. Of course, utilizing XML is not intended to be restrictive either, it is merely one way of providing the information used to help facilitate ad interaction with a host application.

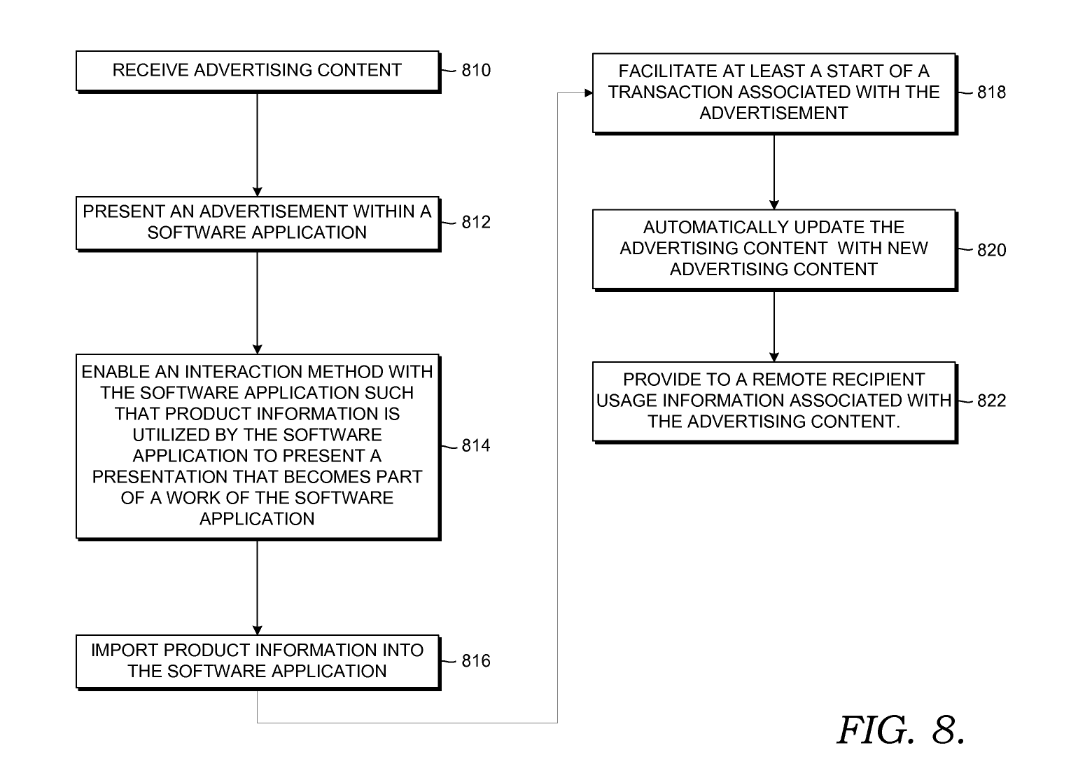

To recapitulate, and with reference to FIG. 8, an illustrative method for enabling an advertisement to interact with a software application is provided. At a step 810, advertising content is received that is to be hosted by the software application. In one embodiment, the advertising content includes an advertisement 126 to be presented as well as an object 128 that includes product information 130 and that can be interacted with by the software application. The product information relates to a product offering that is being promoted by the advertisement. As we have mentioned, this nexus of product information to advertisement is sometimes very tight and is sometimes loose.

At a step 812, advertisement 114 is presented in software application 124. As we have described, this can occur by presenting advertisement 114 in a screen area such as that of 312, 412, or 512. In other embodiments, this may occur by presenting advertisement 126 as part of an icon or as part of a toolbox.

At a step 814, an interaction method is enabled so that software application 124 can utilize product information 130 to present a presentation that becomes part of a work of software application 124. The software application can then be utilized to modify imported product information. We have previously mentioned illustrative works associated with software applications, things such as presentation files and word-processing documents as a couple of examples. The application that receives product information 130 can be used to modify imported product information. That is, if product information 130 is imported into a word-processing program, it can actually be manipulated by a word-processing program. That is, it is not a static picture or representation of data to the tune of not being able to be manipulated by the hosting application 124. In the case of spreadsheets, data are imported into cells of spreadsheets. In the case of drawing files, data are imported that can be manipulated by the drawing application. In the case of development applications, code is imported that can be modified and executed within the developing environment.

The software application 124 can be a thick client application. That is, the application can take the form of a software application akin to what is referred to as a “WIN32” application. The applications can also be web-based applications, applications that be used to modify imported data. As previously mentioned, advertising content 114 can be variable according to attributes of a user so that advertising content includes a first set of data in connection with a first user but a second set of data in connection with a second user. Thus, if the first user appears to be particularly interested in traveling, then that user may receive travel-related advertisements. But if a user appears to more interested in current events, then that user, by way of the same mechanism, may receive news-related offerings.

As mentioned, a visual indication can be presented that said advertisement can be interacted with. An illustrative example of this is referred to in FIG. 3 by numeral 316. We have also described that ways such as thick outlining could be used as well as other ways to visually indicate that advertisement 126 can be interacted with. Anything from colors to a gradient fill to actual text that indicate that the advertisement can be interacted with by host application 124. In some cases, software application 124 itself is modified so that it can interact with advertising content 114. In other embodiments, an enhancement 132 along the lines of a plug-in or add-in can be utilized in connection with a software application 124 so that interaction can be made with advertising content 114.

At a step 816, product information is imported into software application 124. This results in a presentation in software application 124 of imported product information. This imported product information is modifiable by software application 124. Of course, the presentation of imported product information is variable according to the type of software application that software application 124 is. Accordingly, the presentation may take on a first form when the product information is imported in a first software application but may take on a second form when imported into a second software application. We provided examples of this in connection with FIGS. 4 and 5, where the same data gave rise to a different presentation of product information in spreadsheet application 418 as compared to word-processing application 518.

We explained that a transaction-initiation control can be part of transaction data that is imported. If acted on, the transaction-initiation control initiates a transaction related to the advertisement even if this is later in time from when product information 130 was first imported into software application 124. Thus, if product information 130 is imported on January 1, and then a user closes the work that the information was imported into, and then opens it several weeks later, the transaction-initiation control (such as the “ready to buy button” 436) is still active and applicable to at least start a purchasing or some other transaction associated with advertisement 126.

At a step 818, that transaction is shown to at least be started.

In the example we just described, the product information was immediately present and available by way of the work (spreadsheet, document, etc.) incident to a reopening of the work without a need to receive any additional data.

At a step 820, advertising content 114 is automatically updated. In some embodiments, this includes updating only a portion of advertising content 114. For example, perhaps only product information 130 is updated. In other embodiments, transaction-related data may be updated so that pressing a buy button directs a user to a different site. In some embodiments, this includes updating already imported product information. Thus, when an application is newly opened, it is updated with recent data. In one embodiment, product information is updated in real time by way of a live source through, for example, network 118. In other embodiments, product information is updated locally by way of a local source such as local database 134. In other embodiments, updating advertising content includes referencing local data store 134 to receive additional advertisements. In such an example, especially in the case where an internet connection is unavailable or is only available sporadically, much advertising content can be downloaded and stored in data store 134. This local data store 134 can then be used to locally cycle through different advertisements and/or different interaction options.

At a step 822, usage information is provided to a remote recipient such as other party 142. Usage information might include statistic information such as a number of views of certain advertisements or a number of click interactions with the advertisements. These are but a couple of examples to illustrate the aspect of providing usage data to a recipient.

In another embodiment, a method for facilitating advertisement interaction with a software application includes communicating such advertisement content to a remote computing device such as client 112. The advertising content includes an advertisement 126 as well as an object 128, which includes product information 130 as well as transaction-initiation information that enables a transaction associated with the advertisement to be initiated from within a work that was developed by way of the software application. In this way, a recipient of the advertising content is enabled to utilize the software application to interact with the product information by acting on the advertisement 114 to import product information 130 into the software application. As mentioned, ways to act on an advertisement includes things such as double clicking the advertisement or dragging and dropping the advertisement into a relative space.

The advertising content is variable according to attributes of a user such that the advertising content includes a first set of data in connection with the first user but a second set of data in connection with a second user. We have previously elaborated on this aspect of the invention. A presentation of imported product information can vary according to the software application such that the presentation takes on different forms for different types of applications, as also previously described.

Thus, we have described a remote computing device such as device 116 that communicates advertising content such as content 114 to be ultimately received by a client application such as software application 124. The advertising content includes an object that describes how product information within the advertising content is to be directly imported into the client application after some importing event. When such an event occurs, product information is imported into the software application based on the type of software application.

Many different arrangements of the various components depicted, as well as components not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the invention.

It will be understood that certain features and subcombinations are of utility and may be employed without reference to other features and subcombinations and are contemplated within the scope of the claims. Not all steps listed in the various figures need be carried out in the specific order described. For example, block 818 could come after 820 because the initiation of the transaction might be a final interaction between the user and the advertisement.

The invention claimed is:

1. A computer-implemented method integrating product information into a software application to facilitate content interaction with a software application based on attributes of a user, the method comprising:
communicating content to a remote computing device, the content including a product-offering content and an object that includes,
(1) product information associated with the product-offering content that facilitates an integration of the product information into a work of the software application; and
(2) transaction-initiation information that enables a transaction associated with the product-offering content to be initiated from within the work;
such that a recipient of the product-offering content is enabled to utilize the software application to interact with the product information by acting on the product-offering content to import the product information into the software application;
wherein the product-offering content is variable according to attributes of the user such that the product-offering content includes one of a first set of data in connection with a first user and a second set of data in connection with a second user; and
wherein a display of imported product information varies according to the software application such that the display takes on a first form when the product information is imported into a first software application but takes on a second form when imported into a second software application.

2. The method of claim 1, further comprising determining the product-offering content based on user information in a profile.

3. The method of claim 1, further comprising determining the product-offering content based on user login information to the software application.

4. The method of claim 1, further comprising receiving by a recipient an indication of at least a start of a transaction that was initiated from the transaction-initiation information.

5. The method of claim 1, wherein the first software application and the second software application are different types of software applications.

6. The method of claim 1, wherein display of imported product information includes providing a visual indication that the product-offering content can be interacted with.

7. The method of claim 1, wherein the action by which the recipient may interact with the product information includes one or more of the following:
dragging the product-offering content to a destination associated with the software application;
double clicking the product-offering content;
completing a key sequence that invokes the method; or
automatically adding the interaction content based, at least in part, on a portion of the product-offering content.

8. The method of claim 1, wherein the interaction method further includes importing product information into the software application, resulting in a display in the software application of imported product information, which is modifiable by the software application.

9. The method of claim 8, wherein the product information includes transaction data that is useable to display a transaction-initiation control which, if acted on, initiates a transaction related to the product-offering content even if later in time from when the product information was first imported into the software application.

10. The method of claim 9, further comprising facilitating at least a start of a transaction associated with the product-offering content incident to receiving user input by way of the transaction-initiation control.

11. The method of claim 10, wherein the start of the transaction was initiated after a closing and a reopening of the work, and wherein the product information was immediately present and available by way of the work incident to the reopening without a need to receive any additional data.

12. The method of claim 1, further comprising automatically updating the product-offering content with new product-offering content, and wherein automatically updating the product-offering content includes automatically updating imported product information that had been imported into the work.

13. The method of claim 12, wherein automatically updating the interaction content includes one or more of:
providing live content from a remote location;
updating the interaction content from a local data source.

14. The method of claim 1, further comprising providing to remote recipient usage information associated with the product-offering content.

15. A system importing product information into a software application based on the software application type to facilitate interaction of product-offering content with the software application, the system comprising:
a remote computing device that communicates product-offering content ultimately to be received by a client application;
wherein the product-offering content includes an object that describes how product information within the product-offering content is to be directly imported into the client application incident to an importing event; and
incident to an occurrence of the event, the product information is imported into the software application based on a type of software application that the software application is such that the product information takes on a first form if imported into a first type of software application but takes on a second form if imported into a second type of software application.

16. The system of claim 15, wherein the software application includes a selection from the following:
a word-processing application;
a spreadsheet application;
a database program;
a presentation program;
a drawing program;
a messaging application;
an application-development application;
a finance-related application; and
a productivity-enhancement application.

17. The system of claim 15, comprising employing an interaction method allowing the product-offering content to interact with software application.

18. The system of claim 17, wherein interaction methods include dragging product-offering content to a destination associated with software application.

19. The system of claim 18, wherein the destination varies based on the type of software application and the the imported product information is displayed based on the type of software application.

20. A computer system obtaining product information, the computer system comprising:
a database storing product information objects that include view information and import information, wherein the view information specifies how the same product information is rendered differently by different software applications and the import information describes how the product information is to be directly obtained in response to an import event;
and
a client computer that obtains the product information objects when executing a software application in response to user selection of the import event, wherein the client computer skips certain pieces of the product information in the product information objects based on a type associated with the software application but remaining pieces of the product information in the product information objects are accessible to a user of the client computer such that the product information takes on a first form if obtained by a first type of software application and takes on a second form if obtained by a second type of software application.
